(19) United States
(12) Patent Application Publication
(10) Pub. No.: US 2014/0278860 A1
(43) Pub. Date: Sep. 18, 2014

(54) CONTENT DELIVERY SYSTEM WITH CONTENT SHARING MECHANISM AND METHOD OF OPERATION THEREOF

(71) Applicant: Samsung Electronics Co., Ltd., Gyeonggi-Do (KR)

(72) Inventors: Seungeun Lee, Sunnyvale, CA (US); Guy Bar-Nahum, San Francisco, CA (US); Anthony D. Hand, San Jose, CA (US); Sara Kwan, Sunnyvale, CA (US); Nina F. Shih, Mountain View, CA (US); Nastasha Tan, San Francisco, CA (US); Yun Z. Wu, San Francisco, CA (US)

(21) Appl. No.: 13/832,912

(22) Filed: Mar. 15, 2013

(51) Int. Cl. H04L 29/06; G06Q 30/02

(52) U.S. Cl. CPC H04L 65/403; G06Q 30/0214
USPC 705/14.16; 709/204

(57) ABSTRACT

A content delivery system includes: a profile module configured to determine a profile; a current location module, coupled to the profile module, configured to calculate a current location associated with the profile; and a content generation module, coupled to the additional location module, configured to generate a contextual content based on the profile and within a geofence of the current location for displaying on the device, the geofence is for connecting a device to another device.

### TECHNICAL FIELD

An embodiment of the present invention relates generally to a content delivery system, and more particularly to a system for content.

### BACKGROUND

Modern portable consumer and industrial electronics, especially client devices such as navigation systems, cellular phones, portable digital assistants, and combination devices, are providing increasing levels of functionality to support modern life including personalized content services. Research and development in the existing technologies can take a myriad of different directions.

Personalized content services allow users to create, transfer, store, and/or consume information in order for users to create, transfer, store, and consume in the “real world.” One such use of personalized content services is to efficiently transfer or guide users to the desired product or service.

Content delivery system and personalized content services enabled systems have been incorporated in automobiles, notebooks, handheld devices, and other portable products. Today, these systems aid users by incorporating available, real-time relevant information, such as advertisement, entertainment, local businesses, or other points of interest (POI).

However, the current content delivery system does not have an ability to provide a content sharing mechanism, which has become a paramount concern for the consumer. The inability decreases the benefit of using the tool.

Thus, a need still remains for a content delivery system with content sharing mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a content delivery system, including: a profile module configured to determine a profile; a current location module, coupled to the profile module, configured to calculate a current location associated with the profile; and a content generation module, coupled to the additional location module, configured to generate a contextual content based on the profile and within a geofence of the current location for displaying on the device, the geofence is for connecting a device to another device.

An embodiment of the present invention provides a method of operation of a content delivery system including: determining a profile with a control unit; calculating a current location associated with the profile; and generating a contextual content based on the profile and within a geofence of the current location for displaying on the device, the geofence is for connecting a device to another device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a content delivery system with content sharing mechanism in an embodiment of the present invention.

FIG. 2 is a first example of a distribution of a contextual content by the content delivery system.

FIG. 3 is a second example of the distribution of the contextual content by the content delivery system.

FIG. 4 is a third example of the distribution of the contextual content by the content delivery system.

FIG. 5 is a fourth example of the distribution of the contextual content by the content delivery system.

FIG. 6 is a fifth example of the distribution of the contextual content by the content delivery system.

FIG. 7 is a sixth example of the distribution of the contextual content by the content delivery system.

FIG. 8 is a seventh example of the distribution of the contextual content by the content delivery system.

FIG. 9 is an eighth example of the distribution of the contextual content by the content delivery system.

FIG. 10 is a ninth example of the distribution of the contextual content by the content delivery system.

FIG. 11 is a tenth example of the distribution of the contextual content by the content delivery system.

FIG. 12 is an eleventh example of the distribution of the contextual content by the content delivery system.

FIG. 13 is a twelfth example of the distribution of the contextual content by the content delivery system.

FIG. 14 is a thirteenth example of the distribution of the contextual content by the content delivery system.

FIG. 15 is a fourteenth example of the distribution of the contextual content by the content delivery system.

FIG. 16 is a fifteenth example of the distribution of the contextual content by the content delivery system.

FIG. 17 is a sixteenth example of the distribution of the contextual content by the content delivery system.

FIG. 18 is a seventeenth example of the distribution of the contextual content by the content delivery system.

FIG. 19 is an eighteenth example of the distribution of the contextual content by the content delivery system.

FIG. 20 is an exemplary block diagram of the content delivery system.

FIG. 21 is a control flow of the content delivery system.

FIG. 22 is a flow chart of a method of operation of the content delivery system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of an embodiment of the present invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown a content delivery system 100 with content sharing mechanism in an embodiment of the present invention. The content delivery system 100 includes a first device 102, such as a client or a server, connected to a second device 106, such as a client or server, with a communication path 104, such as a wireless or wired network. The content delivery system 100 can also include a third device 108 connected to the first device 102 or the second device 106 with the communication path 104. The third device 108 can be a client or server.

For example, the first device 102 and the third device 108 can be of any of a variety of mobile devices, such as a cellular phone, personal digital assistant, a notebook computer, automotive telematic content delivery system, or other multi-functional mobile communication or entertainment device. The first device 102 and the third device 108 can be a standalone device, or can be incorporated with a vehicle, for example a car, truck, bus, or train. The first device 102 and the third device 108 can couple to the communication path 104 to communicate with the second device 106.

For illustrative purposes, the content delivery system 100 is described with the first device 102 and the third device 108 as a mobile computing device, although it is understood that the first device 102 and the third device 108 can be different types of computing devices. For example, the first device 102 and the third device 108 can also be a non-mobile computing device, such as a server, a server farm, or a desktop computer. For further example, the third device 108 can be a non-mobile computing device, such as a desktop computer, a large format display (LFD), a television (TV) or a computer terminal.

The second device 106 can be any of a variety of centralized or decentralized computing devices. For example, the second device 106 can be a computer, grid-computing resources, a virtualized computer resource, cloud computing resource, routers, switches, peer-to-peer distributed computing devices, or a combination thereof.

The second device 106 can be centralized in a single computer room, distributed across different rooms, distributed across different geographical locations, embedded within a telecommunications network. The second device 106 can have a means for coupling with the communication path 104 to communicate with the first device 102 and the third device 108. The second device 106 can also be a client type device as described for the first device 102.

In another example, the first device 102 and the third device 108 can be a particularized machine, such as a mainframe, a server, a cluster server, rack mounted server, or a blade server, or as more specific examples, an IBM System z10 ™ Business Class mainframe or a HP ProLiant ML™ server. Yet another example, the second device 106 can be a particularized machine, such as a portable computing device, a thin client, a notebook, a netbook, a smartphone, personal digital assistant, or a cellular phone, and as specific examples, an Apple iPhone™, Palm Centro™, Samsung Galaxy™, or Moto Q Global™.

For illustrative purposes, the content delivery system 100 is described with the second device 106 as a non-mobile computing device, although it is understood that the second device 106 can be different types of computing devices. For example, the second device 106 can also be a mobile computing device, such as notebook computer, another client device, or a different type of client device. The second device 106 can be a standalone device, or can be incorporated with a vehicle, for example a car, truck, bus, or train.

Also for illustrative purposes, the content delivery system 100 is shown with the first device 102, the second device 106, and the third device 108 as end points of the communication path 104, although it is understood that the content delivery system 100 can have a different partition between the first device 102, the second device 106, the third device 108, and the communication path 104. For example, the first device 102, the second device 106, or a combination thereof can also function as part of the communication path 104.

The communication path 104 can be a variety of networks. For example, the communication path 104 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104.

Further, the communication path 104 can traverse a number of network topologies and distances. For example, the communication path 104 can include direct connection, personal area network (PAN), local area network (LAN), metropolitan area network (MAN), wide area network (WAN) or any combination thereof.

Referring now to FIG. 2, therein is shown a first example of a distribution of a contextual content 202 by the content delivery system 100. The content delivery system 100 can determine the contextual content 202 distributable and presentable on the first device 102, the third device 108 of FIG. 1, or a combination thereof. FIGS. 2-6 can represent scenarios of serendipitous contextual content discovery. The term “content” refers to encompass or include information, functionality, or a combination thereof. For example, content that can also be functionality can provide users an ability to purchase, download, or view a recommended item.

The contextual content 202 is defined as information relevant to users' profiles. For example, the users can represent those who are using electronic devices. The contextual content 202 is information generated for a device that is in proximity of a location. The contextual content 202 can be generated when the first device 102 is in proximity of a venue location 204 of a venue 206 or a location of another device.

The term “proximity” refers to a state of being within a geographical area. For example, when the first device 102 and the third device 108 are in proximity of each other, they are within a geofence 208, which is defined as a perimeter of a real-world geographic area. For example, the geofence 208 can include a radius from a point location. The geofence 208 provides a region within which devices are enabled to communicate with each other in order to share the contextual content 202. The geofence 208 can represent a boundary of a physical area where users of the devices are able to see each other. For example, the geofence 208 can be associated with a geographical region including a room, a store, a church, a park, or a shopping center where people can meet each other and devices that they are using can send or receive the contextual content 202 from each other.

The venue location 204 is defined as a geographical location of an entity. The venue 206 is defined as an entity where an activity or an event occurs. The venue 206 can represent a point of interest where there are social activities that involve people. For example, the venue 206 can represent including a store, a business, a restaurant, an office, a park, a home, a museum, a public arena, a gas station, a collection of businesses including a shopping mall, or any other point of interest.

The contextual content 202 can be associated with the venue 206 and a user using the first device 102, the third device 108, or a combination thereof. The contextual content 202 can be broadcasted at the venue 206 to a number of devices that are in the proximity of the venue 206 when a current location 210 of the first device 102 is in the proximity of the venue location 204. The current location 210 is defined as a geographical location.

For example, Gerald and Julie are planning a Thanksgiving dinner or generally a Holiday meal together. They head to the venue 206 including a grocery store such as Safeway. As they enter the venue 206, the venue 206 can automatically push or transferring the contextual content 202 to the first device 102 that Gerald is using. The term “automatically” when used with pushing or transferring information refers to a system having a communication method of detecting information on a device and transferring the information to another device. As an example, the contextual content 202 can include today's coupons and in-store services available at the venue 206 that are catered or targeted to Gerald's and Julie's turkey meal noted on their calendar.

Referring now to FIG. 3, therein is shown a second example of the distribution of the contextual content 202 by the content delivery system 100. The contextual content 202 can be auto-prompted on the first device 102. The term “auto-prompted” refers to a system having a communication method of detecting information on a device and transferring the information to another device.

For example, the contextual content 202 can be auto-prompted by presenting or displaying the contextual content 202 on the first device 102. Also for example, the contextual content 202 can be auto-prompted along with an alert including a symbol, a mark, or any other visual or audible indicator presented or displayed on the first device 102.

For example, the contextual content 202 can include in-store services that are auto-prompted on to the first device 102. With the contextual content 202 auto-prompted on the first device 102, Gerald can use the first device 102 to perform a feature comparison 304 based on descriptions 306, prices 308, and ratings 310 of a supply 312.

The feature comparison 304 is defined as an evaluation of supplies. The descriptions 306 are defined as information that provides details about the supply 312. The prices 308 are defined as monetary value for the supply 312. The ratings 310 are defined as evaluation results for the supply 312. The ratings 310 can be based on reviews using a predefined scale or level. The supply 312 is defined as a product or a service provided by an entity.

Referring now to FIG. 4, therein is shown a third example of the distribution of the contextual content 202 by the content delivery system 100. The feature comparison 304 of FIG. 3 can be performed for the supply 312. Based on the ratings 310 of FIG. 3, the contextual content 202 can be generated and pushed to the first device 102. A notification 302 can be generated and presented on the first device 102 to inform a user of the first device 102 that there is the contextual content 202 ready to be reviewed. The notification 302 is defined as information provided as an alert. The notification 302 can be visually or audibly presented.

For example, as Julie compares the supply 312, the first device 102 that Gerald is using can present the notification 302 indicating that the contextual content 202 has additional information with a decision or the ratings 310 about the supply 312. In this example, Julie can make the decision on which product to purchase. Each product can have additional information that the system provides additional context to the user to make a more informed decision. Also for example, the contextual content 202 can include information indicating that the supply 312 is not as well reviewed.

Referring now to FIG. 5, therein is shown a fourth example of the distribution of the contextual content 202 by the content delivery system 100. The fourth example depicts the contextual content 202 including a content service package 502, which is defined as a bundle of various types of information. The content service package 502 can be associated with the venue 206 of FIG. 2. The content service package 502 can include a unified content, which is a collection of various related information.

The content service package 502 can represent information associated with a store or any other point of interest. For example, the content service package 502 can include a map 504, a promotion 506, and the feature comparison 304 including the ratings 310 of FIG. 3 such as a product review. The map 504 is defined as an illustration of an area. For example, the map 504 can include a drawing of a point of interest. As a specific example, the map 504 can include a drawing of a store that illustrates what an inside of the store looks like and thus provides indoor location smartness with specific aisle proximity.

The promotion 506 is defined as information related to the supply 312 of FIG. 3 that is available or provided for a particular time of a day or a specific duration of time. For example, the promotion 506 can include information related to today's specials at a store. Also for example, the promotion 506 can include information related to a discount price that a store offers for a specific time.

For illustrative purposes, the content service package 502 is shown with each of the map 504, the promotion 506, and the feature comparison 304 separately presented one at a time on a display of a device, although it is understood that the content service package 502 can be present in any manner. For example, the map 504, the promotion 506, and the feature comparison 304 can be presented at the same time at different portions of the display of the first device 102, the third device 108 of FIG. 1, or a combination thereof.

It has been discovered that the content service package 502 associated with the venue 206 provides improved user interface. The content service package 502 having the map 504 of the venue 206 provides navigation guidance for users to travel at the venue 206 thereby providing the improved user interface.

Referring now to FIG. 6, therein is shown a fifth example of the distribution of the contextual content 202 by the content delivery system 100. The contextual content 202 can be shadowed so that the user of the first device 102 can view the contextual content 202 later after the user leaves the venue 206. The contextual content 202 can be shadowed by storing a copy of the contextual content 202 in the first device 102.

For example, as the user leaves a store, there are shadows of the applications (apps) the user may find useful later on. As a specific example, the contextual content 202 that is shadowed on the first device 102 can include the content service package 502 of FIG. 5 with a store's online purchasing services or the promotion 506 of FIG. 5 including coupons.

Referring now to FIG. 7, therein is shown a sixth example of the distribution of the contextual content 202 by the content delivery system 100. The sixth example depicts a method of bumping or transferring the contextual content 202 from a device to another device. The contextual content 202 can be bumped or transferred from the first device 102 to the third device 108 or vice versa. FIGS. 7-12 can represent examples of device-to-device content sharing experience or using mobile devices as content remote control to other displays or devices. The term “bump” refers to transmission of information between electronic devices.

For example, the first device 102 can detect that the third device 108 is executing a procedure 702, which is defined as a sequence of tasks for performing a particular function. For example, the procedure 702 can represent an operation including an application or a program. As a specific example, the procedure 702 can represent a service mash-up.

The first device 102 can actively detect the procedure 702 by continuously or periodically monitoring the third device 108 and recognizing that the third device 108 is executing the procedure 702. The first device 102 can surreptitiously detect the procedure 702 by monitoring for the procedure 702 executed on the third device 108 without any intervention from the third device 108. In other words, the third device 108 does not include a function for detecting the presence of the first device 102 within the geofence 208 of FIG. 2 from a location of the third device 108 and thus does not recognize that the first device 102 is monitoring the third device 108. The third device 108 can be within the geofence 208 of the current location 210.

After the procedure 702 is detected, the first device 102 can be used to send a procedure inquiry 706, a procedure request 708, or a combination thereof to the third device 108. Upon receiving the procedure inquiry 706, the third device 108 can be used to send a procedure description 710 of the procedure 702 to the first device 102. Upon receiving the procedure description 710, the first device 102 can be used to send the procedure request 708 to the third device 108. Upon receiving the procedure request 708, the third device 108 can be used to send a copy of the procedure 702 to the first device 102. The first device 102 can receive the procedure 702 and store the procedure 702 in the first device 102 as the contextual content 202 when the venue 206 is within the geofence 208 of the current location 210.

The procedure inquiry 706 is defined as a command for requesting additional or detail information associated with the procedure 702. The procedure request 708 is defined as a command for transmission of the procedure 702. The procedure description 710 is defined as additional or detail information associated with the procedure 702.

As an example, Pavel using the first device 102 can see or detect that Mike using an awesome service mash-up on the third device 108. Pavel using the first device 102 can send the procedure inquiry 706 to ask Mike what the procedure 702 is. Mike can send the procedure description 710 from the third device 108 to the first device 102 in response to the procedure inquiry 706. Pavel can send the procedure request 708 to the third device 108 after Pavel views the procedure description 710 and likes what he reads about the procedure 702. When Mike receives the procedure request 708, Mike can bump or send the procedure 702 to the first device 102.

The procedure inquiry 706, the procedure description 710, the procedure request 708, or a combination thereof can be optional. For example, the first device 102 can detect and get the copy of the procedure 702 without interfacing with the third device 108 when the procedure 702 is readily available and broadcast to the first device 102 to receive when the third device 108 is within the geofence 208 of the current location 210.

Referring now to FIG. 8, therein is shown a seventh example of the distribution of the contextual content 202 by the content delivery system 100. The first device 102 can receive the procedure 702 of FIG. 7 and store the procedure 702 in the first device 102 as the contextual content 202 when the venue 206 is within the geofence 208 of FIG. 2 of the current location 210.

As an example, Gerald sees a hip teenager playing a fascinating game on the third device 108 of FIG. 1 beside him on a train. He thinks his nephew would find the game interesting too. Gerald can use the first device 102 to detect the procedure 702 including the game being executed on the third device 108. Gerald can use the first device 102 to surreptitiously get a shadow of the game so that he can play with it later on as the first device 102 can listen or monitoring for the procedure 702 including interesting services being used or executed nearby.

Referring now to FIG. 9, therein is shown an eighth example of the distribution of the contextual content 202 by the content delivery system 100. The eighth example depicts a mobile gaming environment. The first device 102 and the third device 108 can be share the contextual content 202 among each other. The contextual content 202 can be transmitted from the first device 102 to the third device 108, or vise versa, as users of the first device 102 and the third device 108 interact with each other.

For example, Monica, Lauren, and Mike are at a party playing a mobile game together. Monica and Lauren can use the first device 102 and the third device 108, respectively, as their mobile devices as their game boards. As a specific example, the first device 102 can present half of a game board while the third device 108 can present the other half of the game board. As such, the contextual content 202 can be presented on both the first device 102 and the third device 108.

Referring now to FIG. 10, therein is shown a ninth example of the distribution of the contextual content 202 by the content delivery system 100. The ninth example depicts the contextual content 202 presented on a display device 1002, which is defined as a device that presents the contextual content 202 available for public viewing. For example, the display device 1002 can be electronic equipment including a television (TV) or a projector screen. The contextual content 202 can be presented on the display device 1002 when a display location 1004 of the display device 1002 is within the geofence 208 of the current location 210.

For example, Monica, Lauren, and Mike are at a party playing a mobile game together. As the game gets more riveting, the whole room's attention is on them. Monica takes advantage of the attention and uses the first device 102 to extend the game to the display device 1002 in the room. The party crowd cheers on. The first device 102 can extend the game by transmitting the contextual content 202 from the first device 102 to the display device 1002. The contextual content 202 can be associated with the game that is shared between the first device 102 and the third device 108.

Referring now to FIG. 11, therein is shown a tenth example of the distribution of the contextual content 202 by the content delivery system 100. The tenth example depicts the contextual content 202 shared among the first device 102, the third device 108, and the display device 1002. The contextual content 202 can be shared by the first device 102 by the first device 102 transmitting the contextual content 202 to the third device 108, the display device 1002, or a combination thereof.

For example, Pavel is in a meeting. A presenter mentions a subject that Pavel has also been researching. Pavel shares with his coworkers a chart he came across in his research that may be interesting to the team. Pavel can share the chart by transmitting the contextual content 202 from the first device 102 that he is using to other devices including the third device 108 that one of his coworkers is using, the display device 1002 that the team can view, or a combination thereof. The contextual content 202 can aid group decisions among the team.

Referring now to FIG. 12, therein is shown an eleventh example of the distribution of the contextual content 202 by the content delivery system 100. The eleventh example depicts the contextual content 202 on the display device 1002.

For example, Pavel discusses the chart in the meeting that Pavel has with his coworkers. The chart becomes pivotal to the discussion so the team now wants to project the chart to the display device 1002 as the room's big display to discuss the chart together. Pavel can connect the first device 102 to the display device 1002 and navigate the presentation using the first device 102.

Referring now to FIG. 13, therein is shown a twelfth example of the distribution of the contextual content 202 by the content delivery system 100. The twelfth example depicts the contextual content 202 presented in a multimedia display area 1302 of the first device 102, the third device 108 of FIG. 1, or the display device 1002 of FIG. 10. The multimedia display area 1302 is defined as a portion of a display structure for presenting a combination of various contents. For example, the multimedia display area 1302 can be used to present various contents including text, audio, still images, animation, video, interactivity contents, or a combination thereof. Also for example, the multimedia display area 1302 can represent a portion of a first display interface 2030 of FIG. 20, a second display interface 2040 of FIG. 20, or a third display interface 2070 of FIG. 20. FIGS. 13-15 can represent examples with rolling history of location- or proximity-based content and service packages.

The contextual content 202 can include specific information that is associated with the first device 102, the third device 108, the display device 1002, or a combination thereof. The contextual content 202 can include the specific information that is also associated with a geographical location to where the first device 102, the third device 108, the display device 1002, or a combination thereof will be located.

The contextual content 202 can include information associated with the venue 206 of FIG. 2. For example, the contextual content 202 can include information associated with the venue 206 including a bookstore. As a specific example, the contextual content 202 can include information associated with published documents at the venue 206 including books, magazines, bestsellers, novels, volumes, works, and writings along with authors of the published documents. Also for example, the contextual content 202 can include information associated with the venue 206 including coupons, events, maps, and products that are offered or available at the venue 206.

The multimedia display area 1302 can be used to present the contextual content 202 with a variety of display modes 1304, which are defined as features of presentation. The display modes 1304 can include a display feature including a lock mode and a rolling mode. For example, the lock mode can be used to present the contextual content 202 in a viewing mode that is not scrollable in the multimedia display area 1302 when the lock mode is enabled.

Also for example, the rolling mode can be used to present the contextual content 202 in a viewing mode that is scrollable in the multimedia display area 1302 when the lock mode is disabled. As a specific example, the first device 102 can include a function to allow a user of the first device 102 to horizontally scroll, vertically scroll, or a combination thereof in the display structure of the first device 102 to progressively reveal the contextual content 202 in the multimedia display area 1302. In the rolling mode, the user of the first device 102 can view a rolling history of the contextual content 202 that has been presented.

The contextual content 202 can be associated with the venue location 204 of FIG. 2. The venue location 204 can be determined based on a scheduled event 1306, which is defined as an activity that has been planned. For example, the scheduled event 1306 can include a dinner that has been scheduled at a specific time and date in a calendar of the user of the first device 102. The first device 102 can determine that the venue 206 is nearby a location where the scheduled event 1306 will occur when the first device 102 calculates that the venue location 204 is within the geofence 208 of FIG. 2 of the location of the scheduled event 1306.

By presenting a current time of day 1308 in the multimedia display area 1302, the user of the first device 102 can decide whether to stop by the venue 206 before arriving at the scheduled event 1306. The current time of day 1308 is defined as a specific time in a calendar day.

For example, the first device 102 can also present other information including emails received as well as pending chat messages to be viewed. The other information can be presented in a lower display area of the display structure of the first device 102.

Referring now to FIG. 14, therein is shown a thirteenth example of the distribution of the contextual content 202 by the content delivery system 100. The thirteenth example depicts the contextual content 202 presented in the multimedia display area 1302. The multimedia display area 1302 can be used to present the contextual content 202 with the display modes 1304. For example, the rolling mode can be used to present the contextual content 202 in a viewing mode that is scrollable in the multimedia display area 1302.

As a specific example, the first device 102 can include a function to automatically horizontally scroll, vertically scroll, or a combination thereof the display structure of the first device 102. The first device 102 can automatically scroll the display structure of the first device 102 by periodically changes a viewing content in the display structure for a predetermined duration. For example, a portion of the contextual content 202 can be presented for the predetermined duration and another portion of the contextual content 202 can be presented after the predetermined duration. As another specific example, the contextual content 202 can include a rolling banner display that animates into place every so often for a predetermined duration to show off features of a content or service package.

Referring now to FIG. 15, therein is shown a fourteenth example of the distribution of the contextual content 202 by the content delivery system 100. The fourteenth example depicts scrolling in the multimedia display area 1302 to present a portion of the contextual content 202 based on a recent activity 1502, which is defined as an event that has occurred before the current time of day 1308. As an example, the portion of the contextual content 202 can include a suggested content package based on the recent activity 1502 from a recent, earlier moment.

For example, the recent activity 1502 can be determined by detecting an event that has occurred in a predetermined duration before the current time of day 1308. Also for example, the recent activity 1502 can be determined by detecting for a number of events that have occurred most recently in the predetermined duration before the current time of day 1308. As a specific example, the recent activity 1502 can include events including artists and concerts performed by the artists with the concerts have occurred within the geofence 208 of FIG. 2 of the location of the scheduled event 1306 or the current location 210 of FIG. 2 of the first device 102.

The first device 102 can generate the contextual content 202 with various template possibilities. For example, the contextual content 202 can include a related suggestion 1504, which is defined as information associated with the recent activity 1502.

The related suggestion 1504 can be generated to provide options for a user of the first device 102 to select since the related suggestion 1504 is similar to the recent activity 1502. The related suggestion 1504 can be determined as similar to the recent activity 1502 based on a property of the recent activity 1502 including types, categories, and any other features, as examples. For example, the recent activity 1502 can include a concert that has been playing nearby and the related suggestion 1504 can include music albums that have similar music genres of the music played by the performers at the concert.

Referring now to FIG. 16, therein is shown a fifteenth example of the distribution of the contextual content 202 by the content delivery system 100. The fifteenth example depicts the content service package 502. For example, the content service package 502 can include a mashup of information from more than one source. The term “mashup” refers to a method of combining data, presentation, or functionality from two or more data sources to create services that produce enriched results. FIGS. 16-19 can represent examples of unified content libraries enabling continuous content discovery stream with content mash-ups.

The content service package 502 can be generated to provide a user interface (UI) that supports a continuous content discovery by showing users a layer of information that hints at discovering related content. The content service package 502 can be used to provide the continuous content discovery by presenting various types of information in the same screen of the display structure so that the users do not have to leave one screen or application and switch to another screen or application to view various contents.

The content service package 502 can include the contextual content 202. The content service package 502 can be generated for a user of the first device 102 can view a collection of various related information associated with the contextual content 202. For example, the contextual content 202 can include a movie trailer of a movie named “Lorax”. In this case, the user can view the movie trailer at a top portion of the screen of the display structure.

The content service package 502 can include a background content 1602, which is defined as information associated with the contextual content 202 being presented. For example, the user can select the background content 1602 that is part of the contextual content 202 being presented for additional information. As a specific example, the background content 1602 can include multimedia including pictures in a gallery of similarly related images associated with information presented for the contextual content 202.

The user can view an additional content 1604, which is defined as information that arouses viewers' interest. The additional content 1604 is intended to get attention from the viewers. The additional content 1604 can be provided as part of the content service package 502 via a navigation interface in a bottom portion of the screen of the display structure. The additional content 1604 can be presented with a visual capability that is less than that of the contextual content 202 presented in the top portion of the screen. For example, the additional content 1604 can include teasers that are presented to attract attention or interest from viewers.

For example, the additional content 1604 can be presented with a visual capability with a resolution smaller than a resolution of the contextual content 202. Also for example, the additional content 1604 can include information that can get the viewers' interest including video clips of how the contextual content 202 is made, reviews of the contextual content 202, and features, synopsis, or cast when the contextual content 202 is associated with a movie.

For illustrative purposes, the fifteenth example depicts an arrow within a circle in the display structure to provide an interface for the user to play or initiate a presentation of the contextual content 202 or the additional content 1604, although it is understood that the interface can be provided in any manner. For example, the presentation of the contextual content 202 or the additional content 1604 can be performed by providing a menu in the content service package 502 for the user to select options to play, pause, or repeat the presentation of the contextual content 202 or the additional content 1604. Also for example, the user can optionally input an audible command to initiate the presentation of the contextual content 202 or the additional content 1604.

Referring now to FIG. 17, therein is shown a sixteenth example of the distribution of the contextual content 202 by the content delivery system 100. The sixteenth example depicts the background content 1602. The background content 1602 can be viewed by a user of the first device 102 selecting a portion of the contextual content 202 in the screen of the display structure of FIG. 16.

For example, the background content 1602 can include information associated with the contextual content 202 being presented including a gallery of photos of the movie. While the user is looking at the gallery of the photos, the first device 102 can show or present the map 504 where the user can see point of interests including theatres that are nearby where the movie is showing. The points of interests that are nearby can be within the geofence 208 of FIG. 2 of the current location 210 of FIG. 2 of the first device 102.

Referring now to FIG. 18, therein is shown a seventeenth example of the distribution of the contextual content 202 by the content delivery system 100. The seventeenth example depicts the additional content 1604 as well as the related suggestion 1504 associated with the additional content 1604. For example, the additional content 1604 can include interesting information including a list of actors in a movie.

In this example, the user of the first device 102 can view the additional content 1604 to research voices of the actors of the movie “Lorax”. The user can read details of some of the actors and roles that they play. In a background of the screen, the first device 102 can present the related suggestion 1504 to suggest or recommend an easy way to order movie tickets. The first device 102 can present the related suggestion 1504 including a website or a link to the website, shown as Fandango, for the user to conveniently order the movie tickets.

Referring now to FIG. 19, therein is shown an eighteenth example of the distribution of the contextual content 202 by the content delivery system 100. The eighteenth example depicts the related suggestion 1504.

For example, when the user of the first device 102 is watching a movie at the venue 206 of FIG. 2 including a theater, the first device 102 can detect that the movie is almost over. The first device 102 can search and present another of the venue 206 including a restaurant. As such, the first device 102 providing the venue 206 can make it easy for the user to see nearby restaurants for impromptu dinners, as an example. There can be an overlay of maps and directional information presented along with the related suggestion 1504 to help the user make better decisions.

Also for example, in a background of the first device 102, the first device 102 can save or store a portion of the contextual content 202 including the movie. As a specific example, the first device 102 can save or store movie credits that are shown at the end of the movie so that the user does not have to stay in the venue 206 to the end of the movie. The user can view the portion stored in the first device 102 after leaving the venue 206 to later enjoy blooper and deleted scenes content, as examples.

The term “background of the first device 102” refers to a computing environment where background processes have a lower priority than other processes including foreground processes so that the background processes do not interfere the foreground processes that are executed for interactive applications. In the example described above, the background processes can be executed to store the portion of the contextual content 202 while the foreground processes can be executed to generate and present the related suggestion 1504.

Referring now to FIG. 20, therein is shown an exemplary block diagram of the content delivery system 100. The content delivery system 100 can include the first device 102, the second device 106, the third device 108, and the communication path 104.

The first device 102 or the third device 108 can communicate with the second device 106 over the communication path 104. The first device 102 can send information in a first device transmission 2008 over the communication path 104 to the second device 106. The second device 106 can send information in a second device transmission 2010 over the communication path 104 to the first device 102.

For illustrative purposes, the content delivery system 100 is shown with the first device 102 or the third device 108 as a client device, although it is understood that the content delivery system 100 can have the first device 102 or the third device 108 as a different type of device. For example, the first device 102 or the third device 108 can be a server.

Also for illustrative purposes, the content delivery system 100 is shown with the second device 106 as a server, although it is understood that the content delivery system 100 can have the second device 106 as a different type of device. For example, the second device 106 can be a client device.

For brevity of description in this embodiment of the present invention, the first device 102 and the third device 108 will be described as a client device and the second device 106 will be described as a server device. An embodiment of the present invention is not limited to this selection for the type of devices. The selection is an example of an embodiment of the present invention.

The first device 102 can include a first control unit 2012, a first storage unit 2014, a first communication unit 2016, a first user interface 2018, and a location unit 2020. The first control unit 2012 can include a first control interface 2022. The first control unit 2012 can execute a first software 2026 to provide the intelligence of the content delivery system 100. The first control unit 2012 can be implemented in a number of different manners. For example, the first control unit 2012 can be a processor, an embedded processor, a microprocessor, a hardware control logic, a hardware finite state machine (FSM), a digital signal processor (DSP), or a combination thereof. The first control interface 2022 can be used for communication between the first control unit 2012 and other functional units in the first device 102. The first control interface 2022 can also be used for communication that is external to the first device 102.

The first control interface 2022 can receive information from the other functional units or from external sources, or can transmit information to the other functional units or to external destinations. The external sources and the external destinations refer to sources and destinations physically separate to the first device 102.

The first control interface 2022 can be implemented in different ways and can include different implementations depending on which functional units or external units are being interfaced with the first control interface 2022. For example, the first control interface 2022 can be implemented with a pressure sensor, an inertial sensor, a microelectromechanical system (MEMS), optical circuitry, waveguides, wireless circuitry, wireline circuitry, or a combination thereof.

The location unit 2020 can generate location information, current heading, and current speed of the first device 102, as examples. The location unit 2020 can be implemented in many ways. For example, the location unit 2020 can function as at least a part of a global positioning system (GPS), an inertial content delivery system, a cellular-tower location system, a pressure location system, or any combination thereof.

The location unit 2020 can include a location interface 2032. The location interface 2032 can be used for communication between the location unit 2020 and other functional units in the first device 102. The location interface 2032 can also be used for communication that is external to the first device 102.

The location interface 2032 can receive information from the other functional units or from external sources, or can transmit information to the other functional units or to external destinations. The external sources and the external destinations refer to sources and destinations physically separate to the first device 102.

The location interface 2032 can include different implementations depending on which functional units or external units are being interfaced with the location unit 2020. The location interface 2032 can be implemented with technologies and techniques similar to the implementation of the first control interface 2022.

The first storage unit 2014 can store the first software 2026. The first storage unit 2014 can also store the relevant information, such as advertisements, points of interest (POI), navigation routing entries, or any combination thereof.

The first storage unit 2014 can be a volatile memory, a nonvolatile memory, an internal memory, an external memory, or a combination thereof. For example, the first storage unit 2014 can be a nonvolatile storage such as non-volatile random access memory (NVRAM), Flash memory, disk storage, or a volatile storage such as static random access memory (SRAM).

The first storage unit 2014 can include a first storage interface 2024. The first storage interface 2024 can be used for communication between the location unit 2020 and other functional units in the first device 102. The first storage interface 2024 can also be used for communication that is external to the first device 102.

The first storage interface 2024 can receive information from the other functional units or from external sources, or can transmit information to the other functional units or to external destinations. The external sources and the external destinations refer to sources and destinations physically separate to the first device 102.

The first storage interface 2024 can include different implementations depending on which functional units or external units are being interfaced with the first storage unit 2014. The first storage interface 2024 can be implemented with technologies and techniques similar to the implementation of the first control interface 2022.

The first communication unit 2016 can enable external communication to and from the first device 102. For example, the first communication unit 2016 can permit the first device 102 to communicate with the second device 106, an attachment, such as a peripheral device or a computer desktop, and the communication path 104.

The first communication unit 2016 can also function as a communication hub allowing the first device 102 to function as part of the communication path 104 and not limited to be an end point or terminal unit to the communication path 104. The first communication unit 2016 can include active and passive components, such as microelectronics or an antenna, for interaction with the communication path 104.

The first communication unit 2016 can include a first communication interface 2028. The first communication interface 2028 can be used for communication between the first communication unit 2016 and other functional units in the first device 102. The first communication interface 2028 can receive information from the other functional units or can transmit information to the other functional units.

The first communication interface 2028 can include different implementations depending on which functional units are being interfaced with the first communication unit 2016. The first communication interface 2028 can be implemented with technologies and techniques similar to the implementation of the first control interface 2022.

The first user interface 2018 allows a user (not shown) to interface and interact with the first device 102. The first user interface 2018 can include an input device and an output device. Examples of the input device of the first user interface 2018 can include a keypad, a touchpad, soft-keys, a keyboard, a microphone, or any combination thereof to provide data and communication inputs.

The first user interface 2018 can include the first display interface 2030. The first display interface 2030 can include a display, a projector, a video screen, a speaker, or any combination thereof.

The first control unit 2012 can operate the first user interface 2018 to display information generated by the content delivery system 100. The first control unit 2012 can also execute the first software 2026 for the other functions of the content delivery system 100, including receiving location information from the location unit 2020. The first control unit 2012 can further execute the first software 2026 for interaction with the communication path 104 via the first communication unit 2016.

The second device 106 can be optimized for implementing an embodiment of the present invention in a multiple device embodiment with the first device 102. The second device 106 can provide the additional or higher performance processing power compared to the first device 102. The second device 106 can include a second control unit 2034, a second communication unit 2036, and a second user interface 2038.

The second user interface 2038 allows a user (not shown) to interface and interact with the second device 106. The second user interface 2038 can include an input device and an output device. Examples of the input device of the second user interface 2038 can include a keypad, a touchpad, soft-keys, a keyboard, a microphone, or any combination thereof to provide data and communication inputs. Examples of the output device of the second user interface 2038 can include the second display interface 2040. The second display interface 2040 can include a display, a projector, a video screen, a speaker, or any combination thereof.

The second control unit 2034 can execute a second software 2042 to provide the intelligence of the second device 106 of the content delivery system 100. The second software 2042 can operate in conjunction with the first software 2026. The second control unit 2034 can provide additional performance compared to the first control unit 2012.

The second control unit 2034 can operate the second user interface 2038 to display information. The second control unit 2034 can also execute the second software 2042 for the other functions of the content delivery system 100, including operating the second communication unit 2036 to communicate with the first device 102 over the communication path 104.

The second control unit 2034 can be implemented in a number of different manners. For example, the second control unit 2034 can be a processor, an embedded processor, a microprocessor, a hardware control logic, a hardware finite state machine (FSM), a digital signal processor (DSP), or a combination thereof.

The second control unit 2034 can include a second control interface 2044. The second control interface 2044 can be used for communication between the second control unit 2034 and other functional units in the second device 106. The second control interface 2044 can also be used for communication that is external to the second device 106.

The second control interface 2044 can receive information from the other functional units or from external sources, or can transmit information to the other functional units or to external destinations. The external sources and the external destinations refer to sources and destinations physically separate to the second device 106.

The second control interface 2044 can be implemented in different ways and can include different implementations depending on which functional units or external units are being interfaced with the second control interface 2044. For example, the second control interface 2044 can be implemented with a pressure sensor, an inertial sensor, a microelectromechanical system (MEMS), optical circuitry, waveguides, wireless circuitry, wireline circuitry, or a combination thereof.

A second storage unit 2046 can store the second software 2042. The second storage unit 2046 can also store the relevant information, such as advertisements, points of interest (POI), navigation routing entries, or any combination thereof. The second storage unit 2046 can be sized to provide the additional storage capacity to supplement the first storage unit 2014.

For illustrative purposes, the second storage unit 2046 is shown as a single element, although it is understood that the second storage unit 2046 can be a distribution of storage elements. Also for illustrative purposes, the content delivery system 100 is shown with the second storage unit 2046 as a single hierarchy storage system, although it is understood that the content delivery system 100 can have the second storage unit 2046 in a different configuration. For example, the second storage unit 2046 can be formed with different storage technologies forming a memory hierarchal system including different levels of caching, main memory, rotating media, or off-line storage.

The second storage unit 2046 can be a volatile memory, a nonvolatile memory, an internal memory, an external memory, or a combination thereof. For example, the second storage unit 2046 can be a nonvolatile storage such as non-volatile random access memory (NVRAM), Flash memory, disk storage, or a volatile storage such as static random access memory (SRAM).

The second storage unit 2046 can include a second storage interface 2048. The second storage interface 2048 can be used for communication between the location unit 2020 and other functional units in the second device 106. The second storage interface 2048 can also be used for communication that is external to the second device 106.

The second storage interface 2048 can receive information from the other functional units or from external sources, or can transmit information to the other functional units or to external destinations. The external sources and the external destinations refer to sources and destinations physically separate to the second device 106.

The second storage interface 2048 can include different implementations depending on which functional units or external units are being interfaced with the second storage unit 2046. The second storage interface 2048 can be implemented with technologies and techniques similar to the implementation of the second control interface 2044.

The second communication unit 2036 can enable external communication to and from the second device 106. For example, the second communication unit 2036 can permit the second device 106 to communicate with the first device 102 over the communication path 104.

The second communication unit 2036 can also function as a communication hub allowing the second device 106 to function as part of the communication path 104 and not limited to be an end point or terminal unit to the communication path 104. The second communication unit 2036 can include active and passive components, such as microelectronics or an antenna, for interaction with the communication path 104.

The second communication unit 2036 can include a second communication interface 2050. The second communication interface 2050 can be used for communication between the second communication unit 2036 and other functional units in the second device 106. The second communication interface 2050 can receive information from the other functional units or can transmit information to the other functional units.

The second communication interface 2050 can include different implementations depending on which functional units are being interfaced with the second communication unit 2036. The second communication interface 2050 can be implemented with technologies and techniques similar to the implementation of the second control interface 2044.

The first communication unit 2016 can couple with the communication path 104 to send information to the second device 106 in the first device transmission 2008. The second device 106 can receive information in the second communication unit 2036 from the first device transmission 2008 of the communication path 104.

The second communication unit 2036 can couple with the communication path 104 to send information to the first device 102 in the second device transmission 2010. The first device 102 can receive information in the first communication unit 2016 from the second device transmission 2010 of the communication path 104. The content delivery system 100 can be executed by the first control unit 2012, the second control unit 2034, or a combination thereof.

For illustrative purposes, the second device 106 is shown with the partition having the second user interface 2038, the second storage unit 2046, the second control unit 2034, and the second communication unit 2036, although it is understood that the second device 106 can have a different partition. For example, the second software 2042 can be partitioned differently such that some or all of its function can be in the second control unit 2034 and the second communication unit 2036. Also, the second device 106 can include other functional units not shown in FIG. 20 for clarity.

The third device 108 can include a third control unit 2052, a third storage unit 2054, a third communication unit 2056, a third user interface 2058, and a location unit 2060. The third control unit 2052 can include a third control interface 2062. The third control unit 2052 can execute a third software 2066 to provide the intelligence of the content delivery system 100. The third control unit 2052 can be implemented in a number of different manners. For example, the third control unit 2052 can be a processor, an embedded processor, a microprocessor, a hardware control logic, a hardware finite state machine (FSM), a digital signal processor (DSP), or a combination thereof. The third control interface 2062 can be used for communication between the third control unit 2052 and other functional units in the third device 108. The third control interface 2062 can also be used for communication that is external to the third device 108.

The third control interface 2062 can receive information from the other functional units or from external sources, or can transmit information to the other functional units or to external destinations. The external sources and the external destinations refer to sources and destinations physically separate to the third device 108.

The third control interface 2062 can be implemented in different ways and can include different implementations depending on which functional units or external units are being interfaced with the third control interface 2062. For example, the third control interface 2062 can be implemented with a pressure sensor, an inertial sensor, a microelectromechanical system (MEMS), optical circuitry, waveguides, wireless circuitry, wireline circuitry, or a combination thereof.

The location unit 2060 can generate location information, current heading, and current speed of the third device 108, as examples. The location unit 2060 can be implemented in many ways. For example, the location unit 2060 can function as at least a part of a global positioning system (GPS), an inertial content delivery system, a cellular-tower location system, a pressure location system, or any combination thereof.

The location unit 2060 can include a location interface 2072. The location interface 2072 can be used for communication between the location unit 2060 and other functional units in the third device 108. The location interface 2072 can also be used for communication that is external to the third device 108.

The location interface 2072 can receive information from the other functional units or from external sources, or can transmit information to the other functional units or to external destinations. The external sources and the external destinations refer to sources and destinations physically separate to the third device 108.

The location interface 2072 can include different implementations depending on which functional units or external units are being interfaced with the location unit 2060. The location interface 2072 can be implemented with technologies and techniques similar to the implementation of the third control interface 2062.

The third storage unit 2054 can store the third software 2066. The third storage unit 2054 can also store the relevant information, such as advertisements, points of interest (POI), navigation routing entries, or any combination thereof.

The third storage unit 2054 can be a volatile memory, a nonvolatile memory, an internal memory, an external memory, or a combination thereof. For example, the third storage unit 2054 can be a nonvolatile storage such as non-volatile random access memory (NVRAM), Flash memory, disk storage, or a volatile storage such as static random access memory (SRAM).

The third storage unit 2054 can include a third storage interface 2064. The third storage interface 2064 can be used for communication between the location unit 2060 and other functional units in the third device 108. The third storage interface 2064 can also be used for communication that is external to the third device 108.

The third storage interface 2064 can receive information from the other functional units or from external sources, or can transmit information to the other functional units or to external destinations. The external sources and the external destinations refer to sources and destinations physically separate to the third device 108.

The third storage interface 2064 can include different implementations depending on which functional units or external units are being interfaced with the third storage unit 2054. The third storage interface 2064 can be implemented with technologies and techniques similar to the implementation of the third control interface 2062.

The third communication unit 2056 can enable external communication to and from the third device 108. For example, the third communication unit 2056 can permit the third device 108 to communicate with the second device 106, an attachment, such as a peripheral device or a computer desktop, and the communication path 104.

The third communication unit 2056 can also function as a communication hub allowing the third device 108 to function as part of the communication path 104 and not limited to be an end point or terminal unit to the communication path 104. The third communication unit 2056 can include active and passive components, such as microelectronics or an antenna, for interaction with the communication path 104.

The third communication unit 2056 can include a third communication interface 2068. The third communication interface 2068 can be used for communication between the third communication unit 2056 and other functional units in the third device 108. The third communication interface 2068 can receive information from the other functional units or can transmit information to the other functional units.

The third communication interface 2068 can include different implementations depending on which functional units are being interfaced with the third communication unit 2056. The third communication interface 2068 can be implemented with technologies and techniques similar to the implementation of the third control interface 2062.

The third user interface 2058 allows a user (not shown) to interface and interact with the third device 108. The third user interface 2058 can include an input device and an output device. Examples of the input device of the third user interface 2058 can include a keypad, a touchpad, soft-keys, a keyboard, a microphone, or any combination thereof to provide data and communication inputs.

The third user interface 2058 can include the third display interface 2070. The third display interface 2070 can include a display, a projector, a video screen, a speaker, or any combination thereof.

The third control unit 2052 can operate the third user interface 2058 to display information generated by the content delivery system 100. The third control unit 2052 can also execute the third software 2066 for the other functions of the content delivery system 100, including receiving location information from the location unit 2060. The third control unit 2052 can further execute the third software 2066 for interaction with the communication path 104 via the third communication unit 2056.

A sensor unit 2074 can detect a person's presence. For example, the sensor unit 2074 can detect the person's presence within a detection zone. Examples of the sensor unit 2074 can include a digital camera, video camera, thermal camera, night vision camera, infrared camera, x-ray camera, or the combination thereof. Further examples of the sensor unit 2074 can include a facial recognition device, a finger print scanner, a retina scanner, a physiological monitoring device, light identifier, or a combination thereof.

Referring now to FIG. 21, therein is shown a control flow of the content delivery system 100. People are social beings and with an advent of social networking services, people have increased their socialness by allowing them to use devices to share the content via web-based social services.

The content delivery system 100 can include the first device 102 of FIG. 1, the second device 106 of FIG. 1, the third device 108 of FIG. 1, and the display device 1002 of FIG. 10 connected and communicating with each other. For example, the first device 102 can be connected and communicating with the second device 106, such as another device, for transferring information between the first device 102 and the venue 206 of FIG. 2. Also for example, the first device 102 can be connected and communicating with the third device 108, such as another device. Further, for example, the first device 102 can be connected and communicating with the display device 1002, such as another device.

The content delivery system 100 can include a profile module 2102 for determining information related to or associated with a user of a device. The profile module 2102 can determine a profile 2104 that describes a user of the first device 102, the third device 108, the display device 1002, or a combination thereof. The profile 2104 can be determined by the profile module 2102 searching through databases or sources of information associated with the user. The profile 2104 can be determined by the profile module 2102 providing an interface for a user to enter or manually manage information associated with the user. The profile 2104 can be determined using default settings provided or predetermined by a data shadow service.

The profile 2104 can include a user profile 2106, which is defined as personal information related to a user of a device. For example, the user profile 2106 can include name, address, contact information, age, and gender of the user.

The profile 2104 can include a content interest 2108, which is defined as information that is selected for presenting on a device. For example, the content interest 2108 can represent information that a user wants to know. As a specific example, the content interest 2108 can include favorites or various types of information including productivity, news, finance, favorites, or hobbies, such as photography, arcade games, and movies.

The profile 2104 can include a social graph 2110, which is defined as a relationship among devices. The social graph 2110 can represent a social relationship among users of devices. The social graph 2110 can be used to connect the devices to communicate with each other. The social graph 2110 can be diagrammed such that a user represents a node in a network diagram and lines connecting the node to another node represent social relationships among the users. For example, the social graph 2110 can be used to determine whom the user knows, a depth of his or her relationships, and frequency of contact.

The social graph 2110 can be created using multiple inputs or sources. For example, the social graph 2110 can be created by mapping the user's contacts into a social network structure. As a specific example, the social graph 2110 can be created by mapping all of the user's contacts including friends from accounts in social networks. Also for example, the social graph 2110 can be created by mixing or combining data from multiple social networks. As a specific example, the social graph 2110 can be created by mapping a person's account in a social network to accounts in another social network to create a network diagram larger than that using a single social network to create the social graph 2110.

Further, for example, the social graph 2110 can be created using other information including contact lists, communication events, or a combination thereof to create a network diagram. As a specific example, the social graph 2110 can be created using the contact lists including an address book and a calendar. As another specific example, the social graph 2110 can be created using the communication events including voice calls, text messages, and chat messages. The communication events can be tracked using real-time text-based messages, audible messages, and recordings of real life meetings.

The profile 2104 can include a preference 2112, which is defined as a selection associated with a device. For example, the preference 2112 can represent a selection made by a user of a device. For example, the preference 2112 can include choices including what types of information for the profile module 2102 to select. As a specific example, the preference 2112 can identify what information is public, what information is private, or notification methods for purposes of presenting information to the user.

A user of the first device 102 can configure or adjust what type of information he or she wants to view. For example, the profile module 2102 can provide an interface for the user to configure the preference 2112. For example, the preference 2112 can be configured for selecting information that is public to get the contextual content 202 of FIG. 2 with information readily available for general viewing purposes. Also for example, the preference 2112 can be configured for selecting information that is private or popular contents to avoid getting the contextual content 202 with meaningless or useless information. As a specific example, popular information from someone who has a high degree of respect with music knowledge can be used to generate the contextual content 202.

The content delivery system 100 can include a location module 2114 for calculating a geographical location. The location module 2114 can include a current location module 2116 for calculating the current location 210 of FIG. 2 of the first device 102. The location module 2114 can include an additional location module 2118 for calculating the venue location 204 of FIG. 2 and the display location 1004 of FIG. 10. The venue location 204 or the display location 1004 can be calculated to locate the venue 206 or the display device 1002, respectively, to connect and establish communication for transferring information between the first device 102 and the venue 206 or the display device 1002.

The current location 210, the venue location 204, and the display location 1004 can be calculated by estimating geographic coordinates using a space-based satellite navigation system including Global Positioning System (GPS). The current location 210, the venue location 204, and the display location 1004 can be calculated to determine whether the first device 102, the venue 206 of FIG. 2, the third device 108, and the display device 1002 are within the geofence 208 of FIG. 2 of the current location 210. The first device 102, the second device 106, the third device 108, and the display device 1002 can be connected and communicated with each other when they are within the geofence 208 of the current location 210.

The content delivery system 100 can include contextual content discovery to provide data shadow and broadcast aim to elevate sharing content during real-life experiences via a service that connects the venue 206 and the social graph 2110 of a user of the first device 102, the third device 108, the display device 1002, or a combination thereof. The content delivery system 100 can include a content module 2122 for determining information relevant to a user using a device.

The content module 2122 can include a content discovery module 2124 for searching for information. The content module 2122 can include a content generation module 2126 for generating the contextual content 202. When information is available, the content discovery module 2124 can send a command to the content generation module 2126 to generate information relevant to a user or a group of users using devices within the geofence 208 of the current location 210. The content generation module 2126 can generate the contextual content 202 based on the profile 2104.

The content discovery module 2124 can search for information by having functions for devices to listening to or monitoring for the information to provide or filter content by contextual awareness. The content discovery module 2124 can include functionalities of a device that listens for contextual information with smart voice intelligence without having battery drain issues. The content discovery module 2124 can search for the information by automatically detect that the third device 108 is executing the procedure 702 of FIG. 7. The automatic detection refers to the content discovery module 2124 having a functionality that detects the procedure 702 without the third device 108 broadcasting the procedure 702. The content discovery module 2124 can automatically detect for information by continuously or periodically monitoring the third device 108 and recognizing that the procedure 702 is executing the procedure 702.

The content generation module 2126 can generate the contextual content 202 by generating information that is appropriate for a user of the first device 102 based on the profile 2104. The content generation module 2126 can generate the contextual content 202 using the procedure 702 that is relevant to the profile 2104 for sending to the first device 102. The content generation module 2126 can recognize that users of the first device 102 and the third device 108 have similar parameters based on the profile 2104 of each of the users. The contextual content 202 can be broadcasted from the first device 102 to the third device 108 or vise versa, as users of the first device 102 and the third device 108 interact with each other.

The content discovery module 2124 can detect that the third device 108 is executing the procedure 702. The content discovery module 2124 can generate and send the procedure inquiry 706 of FIG. 7 from the first device 102 to the third device 108 to request information related to the procedure 702. The content discovery module 2124 can generate and send the procedure description 710 of FIG. 7 from the third device 108 to the first device 102 in response to the procedure inquiry 706. The content discovery module 2124 can generate and send the procedure request 708 of FIG. 7 to the third device 108 after the procedure description 710 has been viewed by a user of the first device 102. The procedure 702 can be sent from the third device 108 to the first device 102 after the third device 108 acknowledges the procedure request 708 from the first device 102.

For example, the contextual content 202 can be generated based on the user profile 2106, the content interest 2108, the social graph 2110, the preference 2112, or a combination thereof. As a specific example, the contextual content 202 can be generated with information associated with users who know or associated with each other based on the social graph 2110 and the users have similar favorites based on the content interest 2108 and the preference 2112. As another specific example, the contextual content 202 can be generated to include information related to cameras and photographic images in books, magazines, movies, or television program when the preference 2112 includes photography.

For example, the content generation module 2126 can generate the content service package 502 of FIG. 5 with the map 504 of FIG. 5, the promotion 506 of FIG. 5, and the feature comparison 304 of FIG. 3. As a specific example, the content service package 502 can be generated to include the map 504 of a grocery store, the promotion 506 with a discount price of an item on sales in the grocery store, and the feature comparison 304 showing the ratings 310 of FIG. 3 of the item.

For example, the content discovery module 2124 can monitor the current location 210 of the first device 102. When the venue 206 is within the geofence 208 of the current location 210, the content discovery module 2124 can identify that a user of the first device 102 is shopping for groceries to prepare for a Thanksgiving dinner as described in FIG. 2 based on the user's calendar or task list. The content discovery module 2124 can send a command to the content generation module 2126 to generate the content service package 502 for displaying on the first device 102 to show the user various types of information available at the venue 206.

The content discovery module 2124 can detect the recent activity 1502 of FIG. 15 by recognizing an event that has occurred in a specific duration before the current time of day 1308 of FIG. 13. The recent activity 1502 can be determined by detecting for a number of events that have occurred most recently in the specific duration before the current time of day 1308. Once the recent activity 1502 has been detected, the content discovery module 2124 can send a command to the content generation module 2126 to generate the related suggestion 1504 of FIG. 15 to include in the contextual content 202.

The content generation module 2126 can generate the related suggestion 1504 using information that is similar to the recent activity 1502. The related suggestion 1504 can be determined as similar to the recent activity 1502 based on a property of the recent activity 1502 including types, categories, and any other features, as examples.

The content generation module 2126 can generate the contextual content 202 with either selectively individual content objects as single type of information or a total content with multiple content objects using the content service package 502. The selectively individual content objects refer to information that is based on a viewer or a user of the first device 102 based on the profile 2104. For example, the contextual content 202 can be generated by filtering information and selecting only relevant information based on the profile 2104. The information selected can be from a user using the third device 108 who have similar parameters as those in the profile 2104 of a user of the first device 102, where the users are related based on the social graph 2110.

The content generation module 2126 can generate a content summary 2128 with content categories 2130 and a count 2132 for each of the content categories. The content summary 2128 is defined as a list of various types of information. The content categories 2130 are defined as types of information. The count 2132 is defined as a numerical value indicating how much content is available. The content summary 2128 can be generated with information associated at the venue 206 based on the profile 2104. The content summary 2128 provides a user of the first device 102 an idea of what types of information is available and decides what information he or she is interested in viewing.

The content discovery module 2124 can detect what types of information that is shared by a user of the third device 108 or users of devices at the venue 206. The content discovery module 2124 can aggregate or combine information from the users at the venue 206 who are sharing information. The content discovery module 2124 can notify the content generation module 2126 to select the procedure 702 used the most at the venue 206 thereby determining that the procedure 702 is the most popular information shared at the venue 206.

The content discovery module 2124 can detect for a recommendation 2134 from a user of the third device 108. The recommendation 2134 is defined as suggestion for particular information. The user of the third device 108 can provide and share the recommendation 2134 along with the ratings 310 of particular information. Once the recommendation 2134 is detected, the content generation module 2126 can determine of the information suggested by the recommendation 2134 is appropriate based on the profile 2104. For example, the recommendation 2134 is related to the procedure 702 with the ratings 310 indicate that the procedure 702 is highly recommended based on ease of use. The procedure 702 can be sent to a user of the first device 102 as a trial version of an application or a chapter or a preview of a book, as examples.

The content discovery module 2124 can optionally access the social graph 2110 to generate a list of users who are sharing contents, who are searching for contents, or who like similar topics based on the user profile 2106, the content interest 2108, the preference 2112, or a combination thereof. The profile 2104 provides a method of filtering out and selecting relevant information especially when there is so much information available at the venue 206.

The content discovery module 2124 can include a serendipitous contextual content discovery, which refers to a method of detecting relevant information associated with the profile 2104 while users of devices are within the geofence 208 of the current location 210 and sharing the relevant information. The serendipitous contextual content discovery provides the method of automatically detecting such relevant information for subsequently generating the contextual content 202 by the content generation module 2126 without user's intervention to request for information.

The content generation module 2126 can generate the contextual content 202 based on the venue 206 and the profile 2104 including the content interest 2108 or the preference 2112. The profile 2104 can be associated with a user of the first device 102, the third device 108, the display device 1002 or a combination thereof. For example, when the content interest 2108 includes music, the content generation module 2126 can generate the content interest 2108 with information related to music at the venue 206 including a music store. Also for example, when the content interest 2108 includes movies, the content generation module 2126 can generate the content interest 2108 with information related to movies at the venue 206 including a movie theater.

The contextual content 202 can be selected based on information from any one of the first device 102, the third device 108, or the display device 1002. For example, the contextual content 202 for presenting on the first device 102 can be selected using the information stored and presented on a remote display of the third device 108 or the display device 1002.

As the user of the first device 102 enters the venue 206, other users including the user of the third device 108 within close proximity of the user of the first device 102 as well as the venue 206 can see the user of the first device 102. Details about the user of the first device 102 including the profile 2104 can be viewed by the other users nearby on their mobile devices including the third device 108. However, the details or the profile 2104 of the user using the first device 102 shared out can vary based on the venue 206 and relationship with the other users including the user of the third device 108 in their hyper-local context. The term hyper-local refers a group of users of devices at the venue 206 within proximity from each other.

The content delivery system 100 can include a comparison module 2136 for providing a method of determining relationship between supplies. The comparison module 2136 can provide the method of determining the relationship between the supplies by generating the feature comparison 304 based on the descriptions 306 of FIG. 3, the prices 308 of FIG. 3, and the ratings 310 of the supply 312 of FIG. 3. The feature comparison 304 can be generated for the supply 312 including products and services.

For example, the feature comparison 304 can be generated by comparing the descriptions 306 of the supply 312 to those of another of the supply 312. If the descriptions 306 matches the profile 2104 including the user profile 2106, the content interest 2108, and the preference 2112, the comparison module 2136 can generate the feature comparison 304 to indicate that the descriptions 306 matches what the profile 2104 indicates.

Also for example, the feature comparison 304 can be generated by comparing the prices 308. If the prices 308 are lower or higher than those of another of the supply 312, the comparison module 2136 can generate the feature comparison 304 to recommend that the supply 312 is a good buy or a bad buy, respectively.

Further, for example, the feature comparison 304 can be generated by comparing the ratings 310. If the ratings 310 are higher or lower than those of another of the supply 312, the comparison module 2136 can generate the feature comparison 304 to recommend that the supply 312 is a good buy or a bad buy, respectively.

The content delivery system 100 can include a presentation module 2138 for delivering information. The presentation module 2138 can deliver the information by presenting the contextual content 202. The contextual content 202 can be broadcasted from the venue 206 to the first device 102, the third device 108, the display device 1002, or a combination thereof. The contextual content 202 can be broadcasted from one of devices including the first device 102, the third device 108, and the display device 1002 to another of the devices by the presentation module 2138. For example, the content generation module 2126 can send the contextual content 202 on the first device 102 to the presentation module 2138 to present on the third device 108.

The contextual content 202 can be broadcasted or pushed at the venue 206 to a number of the devices that are in proximity of the venue 206. The contextual content 202 can be transmitted from the venue 206 or one of the devices to another of the devices when the venue 206 and the devices are in proximity of each other. The contextual content 202 determined in the proximity is beneficial to those who are in the same area to take advantage of immediate local information. For example, if a user walks into a coffee shop for the first time, employees of the coffee shop would say or recommend everything. However, if the user looks at the preference 2112 of other people in the proximity, the user can get an idea of what local people like.

For example, the venue 206 representing a gym can push or transmit the contextual content 202 with relevant information to the devices including the gym's health monitoring or personal coach applications (apps). Also for example, the venue 206 representing a grocery store can push or transmit the contextual content 202 with relevant information to the devices including a store map, coupons, and specials for the day.

The contextual content 202 can be auto-prompted on or automatically broadcasted to any of the devices. For example, the contextual content 202 can be auto-prompted or automatically broadcasted by presenting or displaying the contextual content 202 on the first device 102 without any request for the information from the first device 102.

The contextual content 202 can be presented in the multimedia display area 1302 of FIG. 13 of any of the devices based on the display modes 1304 of FIG. 13 including the lock mode and the rolling mode. For example, the lock mode can be used to present the contextual content 202 in a viewing mode that is not scrollable in the multimedia display area 1302. Also for example, the rolling mode can be used to present the contextual content 202 in a viewing mode that is scrollable in the multimedia display area 1302.

The presentation module 2138 can generate a shadow content 2140, which is defined as a copy of the contextual content 202 or information related to the contextual content 202. The shadow content 2140 can be information associated with the venue 206 or a device including the first device 102, the third device 108, and the display device 1002. The shadow content 2140 can represent content or information that “sticks” on the venue 206 or remains at the venue location 204 by a user's presence at the venue 206 and can be viewable by others nearby if the devices are actively looking for information. For example, the shadow content 2140 of the contextual content 202 can represent an individual content object's “shadow”.

The shadow content 2140 can be generated based on a user's setting. The shadow content 2140 can be generated by the presentation module 2138 providing an interface for the user to enable or disable the generation of the shadow content 2140.

The shadow content 2140 can include a portion of the contextual content 202. For example, the shadow content 2140 can include an individual content object from the contextual content 202.

The shadow content 2140 can optionally include all of the contextual content 202. For example, the shadow content 2140 can include a user's total content shadow, which can include all of the content that the user is sharing.

The shadow content 2140 can slowly fade once the user leaves the venue 206. The shadow content 2140 stored in the first device 102 or the third device 108 can be gradually removed instead of being abruptly and completely removed right after the first device 102 or the third device 108, respectively, is no longer within the geofence 208 of the venue 206. The shadow content 2140 can be deleted by the devices or remain at the venue 206 for a specific duration 2142, which is defined as a predetermined time interval. The shadow content 2140 can fade away as the devices are no longer within the geofence 208 of the venue 206.

For example, the shadow content 2140 can optionally be stored in the second device 106 including a computing resource such as cloud computing data storage or a server available through the internet. The first device 102, the third device 108, or the display device 1002 can access the shadow content 2140 stored in the second device 106.

The shadow content 2140 of the device can remain at the venue 206 for the specific duration 2142 after the device is no longer within the geofence 208 of the venue 206. For example, the shadow content 2140 of the venue 206 or of one of the devices can be stored in another of the devices until the shadow content 2140 is deleted by the another of the devices. Further, for example, the shadow content 2140 of the venue 206 or of one of the devices can be stored in another of the devices for the specific duration 2142 after the one of the devices is no longer within the geofence 208 of the venue 206.

The specific duration 2142 can be predetermined based on how the contextual content 202 ranks in relation to other objects or information available from other users. The specific duration 2142 can be predetermined based on a number of factors. The factors can include a presence time 2144, a recommendation reputation 2146, a promotional level 2148, a content quality 2150, or a combination thereof. The presence time 2144 is defined as duration when a user of one of the devices is present at the venue 206. The presence time 2144 can be determined by recording a total time when the current location 210 is within the geofence 208 of the venue 206.

The recommendation reputation 2146 is defined as ranking of the recommendation 2134. For example, the recommendation reputation 2146 can represent a user's reputation or popularity for providing opinions that are reliable and helpful. Also for example, the recommendation reputation 2146 can be expressed in terms of a range of numerical values with one end of the range indicates the best recommendation and an opposite end of the range indicates the worst recommendation. Also for example, the recommendation reputation 2146 can be expressed in terms of a number of ranking levels. As a specific example, the recommendation reputation 2146 can be expressed with three ranking levels—best, average, and worst.

The promotional level 2148 is defined as an indication of how much effort used in order to attract someone's attention to view information being presented. The promotional level 2148 can represent a promotional consideration of content's right owner. For example, the promotional level 2148 can be expressed in terms of a number of effort levels. As a specific example, the promotional level 2148 can be expressed with two effort levels—low and high.

The content quality 2150 is defined as a feature that indicates how good information is. The content quality 2150 can be determined based on reliability, recency, timeliness, completeness, and helpfulness, as examples. For example, the content quality 2150 can be determined by reliability of information being presented based on how accurate the information is. Also for example, the content quality 2150 can be expressed in terms of a number of reliability levels or symbols. As a specific example, the content quality 2150 can be expressed with five symbols using stars with one star being the worst quality and five stars being the best quality.

For example, the recency can indicate how up to date the contextual content 202 is. Also for example, the timeliness can indicate whether the contextual content 202 is applicable to the time of day or is in time for the user to view the contextual content 202 such that the contextual content 202 is not stale information. Further, for example, the completeness can refer to the contextual content 202 having adequate information for the user to read and understand the entire description in order for the user to determine if he or she is to inquire further about the subject included in the contextual content 202. Yet further, for example, the helpfulness can refer to the contextual content 202 having useful information that can assist the user making decisions whether to obtain a product or a service associated with the contextual content 202.

As an example, the shadow content 2140 can include a trial version of a game as a promotion for a number of days. As another example, the shadow content 2140 can include information associated with movies including information about a book when the contextual content 202 includes a movie that is showing at the venue 206.

The shadow content 2140 can be presented using the notification 302 of FIG. 3 that can be presented on the devices including the first device 102, the third device 108, or the display device 1002. The notification 302 can be automatically popped up or presented without having the devices request for the shadow content 2140. The presentation of the shadow content 2140 can be integrated into any application providing ease-of-use so that users of the devices not have to open another application to view the shadow content 2140.

The notification 302 can be visually distinct and thus more noticeable compared to other features being presented at the same time. For example, the notification 302 can be shinier than the other features being presented. For a specific example, the notification 302 can be presented using noticeable marks including a ribbon that is shinier or uses different colors. For another specific example, the notification 302 can be displayed in a foreground while other information is presented in a background of a screen display.

The notification 302 can be presented on the devices only if users of the devices share the same social network based on the social graph 2110. For example, a user of the first device 102 can receive the shadow content 2140 from a user of the third device 108 if the social graph 2110 of one of these users includes the other user as being in the same social network.

The notification 302 can be presented anonymously without any indication of a source of the information being presented. The notification 302 can optionally be presented along with a content identification 2152, which is defined as a source from where information being presented originates. For example, the content identification 2152 can include information associated with a user of the third device 108 or the display device 1002 who shares information with a user of the first device 102.

Presentation of the content identification 2152 can be configurable by a user of the devices. For example, the content identification 2152 can be configured by the presentation module 2138 providing an interface for the user to set enable or disable the presentation of the content identification 2152.

The notification 302 can be presented visually, audibly, or a combination thereof. For example, the notification 302 can be visually presented by being displayed in a foreground while other information is presented in a background of a screen display. Also for example, the notification 302 can be audibly presented by presenting an audible alert using different types of sounds. Further, for example, the notification 302 can be presented with a multimedia content with images and sounds.

The notification 302 can be presented for purposes of indicating to a user of a device that other devices are within the geofence 208 from a location of the device. For example, the notification 302 can be presented on the first device 102 to indicate that the third device 108 or the display device 1002 is within the geofence 208 of the current location 210.

The notification 302 can include information associated with a user of a device. For example, the notification 302 having information associated with the profile 2104 of a user of the third device 108 can be presented on the first device 102. A user of the first device 102 can view details about the user of the third device 108 to get an idea of what information the user of the third device 108 likes including favorites based on the content interest 2108 or the preference 2112 from the profile 2104 of the user of the third device 108. Sharing the profile 2104 can allow the users of the devices to share the contextual content 202 when the users have common preferences such as music genres, game types, and hobbies.

The presentation module 2138 can include methods for content push notification. For example, the presentation module 2138 can include a passive or manual presentation mode. As a specific example, the additional content 1604 of FIG. 16 representing teasers of relevant content can be presented when the first device 102 is in idle mode, screensaver mode, or lock mode. As another specific example, the additional content 1604 or the notification 302 can be presented using a digital signage in an augmented reality view on the first device 102, the third device 108, or the display device 1002.

For example, the presentation module 2138 can include a direct presentation mode. As a specific example, the notification 302 can be presented by directly pushing or presenting the notification 302 to the first device 102, the third device 108, or the display device 1002. As another example, the notification 302 can be presented using sound of a whistle for attention on the first device 102, the third device 108, or the display device 1002. As a further example, the notification 302 can be presented using vibration on the first device 102, the third device 108, or the display device 1002. As a further example, the notification 302 can be presented by sending a text message to the first device 102, the third device 108, or the display device 1002. As a further example, the notification 302 can be presented by the presentation module 2138 by making a telephone call to a user using the first device 102, the third device 108, or the display device 1002 to provide real-time audio guide to indicate availability of the contextual content 202.

The contextual content 202, the shadow content 2140, the notification 302, or a combination thereof can be pushed or transmitted to the devices based on a number of presentation rules 2154, which are defined as conditions under which information is delivered or presented. The presentation rules 2154 can include conditions to consider whether a user of a device is a repeat customer at the venue 206, purchased something at the venue 206, considering a purchase, or wakes the device when in the venue 206. The presentation rules 2154 can indicate that the user is likely or potentially be interested in viewing the contextual content 202.

The content discovery module 2124 can keep track of a past event 2156 and a current event 2158 of a user using a device. The past event 2156 is defined as an activity that has occurred before a device is located at the venue 206. The current event 2158 is defined as an activity that occurs while the device is at the venue 206. The content discovery module 2124 can transmit the presentation rules 2154 along with the past event 2156 and the current event 2158 to the presentation module 2138.

The presentation module 2138 can present or deliver the contextual content 202, the shadow content 2140, the notification 302, and the procedure 702 based on the presentation rules 2154. For example, when the user of the first device 102 was at the venue 206, the current location module 2116 could detect that the current location 210 was within the geofence 208 of the venue 206. The current location module 2116 can send a command to the content discovery module 2124 to record the past event 2156 to indicate that the user of the first device 102 has been at the venue 206 representing a store and thus is a repeat customer of the store if the user subsequently goes back to the store.

Also for example, the content discovery module 2124 can detect when the user of the first device 102 purchased something in the store and record the past event 2156 to indicate that the user has made a purchase at the store. Further, for example, the content discovery module 2124 can detect when the user is reviewing the feature comparison 304, the descriptions 306, the prices 308, or the ratings 310 and record the current event 2158 to indicate that the user can potentially make a purchase. Further, for example, the content discovery module 2124 can detect when the user wakes or power up the first device 102 and record the current event 2158 to indicate that the user can potentially be interested in viewing the contextual content 202 after the first device 102 is powered on.

The content discovery module 2124 can detect that a user of a device has decided to download or obtain the contextual content 202 from a user of another device and send a command to the presentation module 2138 to generate the notification 302 to notify the user of the another device. For example, a user of the first device 102 has received the contextual content 202 from the third device 108. The presentation module 2138 can present the notification 302 on the third device 108 to indicate that the contextual content 202 has been received by the first device 102.

The content generation module 2126 can generate the contextual content 202 based on the recommendation reputation 2146, the promotional level 2148, the content quality 2150, or a combination thereof. For example, the contextual content 202 can be generated using information from a user if the recommendation reputation 2146 of the user indicates that the user has provided the best recommendations based on feedbacks from other users. Also for example, the contextual content 202 can be generated using information from a content's right owner if the promotional level 2148 provided by the owner is high.

The content delivery system 100 can include an award module 2160 for determining information as reward associated with the contextual content 202. In order to incentivize users to participate in the content delivery system 100, the award module 2160 can be used to reward the users using points or a similar type of tabulation scheme for sharing and consuming information in content engagement events. The award module 2160 can determine the information as reward associated with the contextual content 202 by generating award points 2162, which are defined as numerical values that quantitatively indicate how much users of devices sharing the contextual content 202 have earned.

The award points 2162 can be determined based on a type, a commercial value, or the promotional level 2148, including the promotional consideration of the content's right owner, of the contextual content 202. The award points 2162 can be accumulated and used by a user of a device to spend for virtual goods, application (app) store credits, discounts, or gift cards at a participating retail store or restaurants, as examples.

The award points 2162 can be determined based on the contextual content 202 being shared. For example, if a user of the third device 108 has the contextual content 202 to share and a user of the first device 102 receives and views the contextual content 202, the award points 2162 can be calculated by accumulating the award points 2162 with a predetermined numerical value.

For example, the award points 2162 can be accumulated with an extensive number of points that are determined by a supplier of the supply 312 including a product or a service. As a specific example, a company wants to sponsor a point system that offers the award points 2162 to users. If the users view the contextual content 202 or the shadow content 2140, the users can receive coupons or something redeemable for products and services. The users can also get samples, products, or services for free or at a discount price.

If the contextual content 202 is related to a movie and the user of the first device 102 views information about the movie including casts, synopsis, and the ratings 310, the award points 2162 can be accumulated with another predetermined numerical value as additional points that the user of the third device 108 has earned. If the user of the first device 102 watches a trailer of the movie, the award points 2162 can be accumulated with a further predetermined numerical value as additional points that the user of the third device 108 has earned. If the user of the first device 102 goes to watch the movie at a theater, the award points 2162 can be further accumulated with a yet further predetermined numerical value.

As a specific example, Anna enters the venue 206 including a local coffee shop. As she enters the local coffee shop, she looks at the first device 102 that she is using including a mobile device and can see many pieces of content available from people both currently at the venue 206 and the shadow content 2140 from those who were recently there. While Anna sits at the local coffee shop, other customers can receive the notification 302 about the contextual content 202 that Anna is making available or broadcasting. In addition, as Anna sits longer at the local coffee shop, the shadow content 2140 of the contextual content 202 that Anna is sharing gets stronger and the contextual content 202 is being surfaced higher compared to other information that is concurrently shared on devices of people nearby her. For example, the contextual content 202 and the shadow content 2140 can represent Anna's content objects (including favorites and recommendations) and total content “shadow”, respectively.

Bobby, who is sitting diagonally from Anna, notices that the third device 108 that he is using is presenting the notification 302 notifying him of Anna's interest in arcade games based on the content interest 2108 from the profile 2104 associated with Anna Being curious, Bobby looks at a list of a number of the procedure 702 including games that Anna has been playing. He finds a game of interest from the list and decides to download it. Anna gets the notification 302 indicating that Bobby has considered the recommendation 2134 from Anna and has downloaded the game. The award module 2160 sends a command to the presentation module 2138 to generate and send the notification 302 to the first device 102 to notify Anna that she has received the award points 2162 including a number of credits, which makes her very happy. She can use the award points 2162 to purchase a new set of color palettes in a popular mobile drawing game application (app).

Bobby loves his new game that he has downloaded and spends a little while playing the new game. As he is always happy to share good stuff with others, Bobby adds the new game to his collection of publicly shared content shadows.

After getting plenty of caffeine, Anna leaves the local coffee shop. Because she was at the local coffee shop for a couple of hours and with the recommendation reputation 2146 and the content quality 2150 of her shared content, the shadow content 2140 from Anna can remain at the venue 206 for the specific duration 2142 of a couple of hours. The shadow content 2140 from Anna can remain at the venue 206 for a while longer than shadows of other information from sources with lower reputation and lower content quality. The presentation module 2138 can determine the specific duration 2142 as to how long the shadow content 2140 can remain visible or available at the venue 206 and slowly “fade” from an aggregated view of all shadows currently available at the venue 206.

The profile module 2102 can be implemented with the first device 102, the second device 106 of FIG. 1, the third device 108, or a combination thereof. For example, the profile module 2102 can be implemented with the first control unit 2012 of FIG. 20, the first storage unit 2014 of FIG. 20, the first communication unit 2016 of FIG. 20, the first user interface 2018 of FIG. 20, or a combination thereof. For a specific example, the first control unit 2012 can be implemented to determine the profile 2104.

The current location module 2116 can be implemented with the first device 102, the second device 106, the third device 108, or a combination thereof. For example, the current location module 2116 can be implemented with the first control unit 2012, the first storage unit 2014, the first communication unit 2016, the first user interface 2018, the location unit 2020 of FIG. 20, or a combination thereof. For a specific example, the first control unit 2012 can be implemented to calculate the current location 210 associated with the profile 2104.

The additional location module 2118 can be implemented with the first device 102, the second device 106, the third device 108, or a combination thereof. For example, the additional location module 2118 can be implemented with the first control unit 2012, the first storage unit 2014, the first communication unit 2016, the first user interface 2018, the location unit 2020, or a combination thereof. For a specific example, the first control unit 2012 can be implemented to calculate the display location 1004 within the geofence 208 of the current location 210.

The content discovery module 2124 can be implemented with the first device 102, the second device 106, the third device 108, or a combination thereof. For example, the content discovery module 2124 can be implemented with the first control unit 2012, the first storage unit 2014, the first communication unit 2016, the first user interface 2018, or a combination thereof. For a specific example, the first control unit 2012 can be implemented to automatically detect that the third device 108 is executing the procedure 702, determine that users of the first device 102 and the third device 108 have similar parameters in the profile 2104, and monitor the current location 210 of the first device 102.

The content generation module 2126 can be implemented with the first device 102, the second device 106, the third device 108, or a combination thereof. For example, the content generation module 2126 can be implemented with the first control unit 2012, the first storage unit 2014, the first communication unit 2016, the first user interface 2018, or a combination thereof. For a specific example, the first control unit 2012 can be implemented to generate the contextual content 202 based on the profile 2104 at the venue location 204 within the geofence 208 of the current location 210 for displaying on the first device 102. For another specific example, the first control unit 2012 can be implemented to generate the contextual content 202 based on the content interest 2108, the social graph 2110, the recommendation reputation 2146, and the content quality 2150.

The comparison module 2136 can be implemented with the first device 102, the second device 106, the third device 108, or a combination thereof. For example, the comparison module 2136 can be implemented with the first control unit 2012, the first storage unit 2014, the first communication unit 2016, the first user interface 2018, or a combination thereof. For a specific example, the first control unit 2012 can be implemented to generate the feature comparison 304 based on the descriptions 306, the prices 308, and the ratings 310 of the supply 312.

The presentation module 2138 can be implemented with the first device 102, the second device 106, the third device 108, or a combination thereof. For example, the presentation module 2138 can be implemented with the first control unit 2012, the first storage unit 2014, the first communication unit 2016, the first user interface 2018, or a combination thereof. For a specific example, the first control unit 2012 can be implemented to generate the shadow content 2140 based on the contextual content 202 and present the contextual content 202 based on the presentation rules 2154.

The award module 2160 can be implemented with the first device 102, the second device 106, the third device 108, or a combination thereof. For example, the award module 2160 can be implemented with the first control unit 2012, the first storage unit 2014, the first communication unit 2016, the first user interface 2018, or a combination thereof. For a specific example, the first control unit 2012 can be implemented to determine the award points 2162 based on the promotional level 2148 for recommending the contextual content 202.

The current location module 2116 can be coupled to the profile module 2102 and the additional location module 2118. The additional location module 2118 can be coupled to the content discovery module 2124. The content discovery module 2124 can be coupled to the content generation module 2126. The content generation module 2126 can be coupled to the comparison module 2136. The comparison module 2136 can be coupled to the presentation module 2138. The presentation module 2138 can be coupled to the award module 2160.

It has been discovered that the contextual content 202 generated based on the profile 2104 and within the geofence 208 of the current location 210 provides an effective content sharing mechanism. The effectiveness is a result of using relevant information that is associated with the user profile 2106, the content interest 2108, the social graph 2110, and the preference 2112 of the users who are nearby each other within the geofence 208 and have similarities among one another. The effectiveness is also a result of connecting the first device 102, the second device 106, the third device 108, and the display device 1002 within the geofence 208 of the current location 210 for the devices to communicate with each other. The effectiveness solves problems encountered by systems involved with siloed content, services, and information sources as wells as problems related to difficulties in sharing contents between people.

It has also been discovered that the shadow content 2140 of the contextual content 202 remained at the venue location 204 or stored in the first device 102, the third device 108, or the display device 1002 for the specific duration 2142 provides improved availability of relevant information for the users to view later.

It has further been discovered that the contextual content 202 generated based on the recommendation reputation 2146, the promotional level 2148, and the content quality 2150 provides improved quality of information being delivered thereby eliminating useless information.

It has further been discovered that the award points 2162 determined based on the contextual content 202 and the promotional level 2148 provide a reward system that is effective in incentivizing users to participate in the content delivery system 100.

It has further been discovered that the content discovery module 2124 automatically detecting for the procedure 702 provides improved user interface thereby eliminating a need for the users to manually search for information.

It has further been discovered that the specific duration 2142 predetermined based on the presence time 2144, the recommendation reputation 2146, the promotional level 2148, and the content quality 2150 provides improved availability of relevant information for the users to view later.

It has further been discovered that presenting the contextual content 202 based on the presentation rules 2154 provides improved information delivery since the contextual content 202 is delivered based on specific conditions to eliminate junk or unwanted messages. The specific conditions are based on whether a user of the first device 102, the third device 108, or the display device 1002 is a repeat visitor at the venue 206, purchased something at the venue 206, considering a purchase, or wakes the device when in the venue 206. The specific conditions provide solutions to challenges of how to appropriately push or deliver contents and service packages to the device as well as reducing the number of clicks the user would have to do.

It has further been discovered that the presentation module 2138 delivering the contextual content 202, the shadow content 2140, and the notification 302 provides an effective delivery method using passive or direct presentation modes resulting in an appropriate push-content notification method that is not obtrusive and annoying.

The physical transformation of determining the profile 2104 to generate the contextual content 202 at the venue location 204 within the geofence 208 of the current location 210 for displaying on the first device 102 results in movement in the physical world, such as people using the first device 102, the second device 106, the third device 108, or a combination thereof, based on the operation of the content delivery system 100. As the movement in the physical world occurs, the movement itself creates additional information that is converted back in to determine the profile 2104 to generate the contextual content 202 for the continued operation of the content delivery system 100 and to continue the movement in the physical world.

The content delivery system 100 describes the module functions or order as an example. The modules can be partitioned differently. For example, the current location module 2116 and the additional location module 2118 can be combined. Each of the modules can operate individually and independently of the other modules.

Furthermore, data generated in one module can be used by another module without being directly coupled to each other. For example, the content generation module 2126 can receive the profile 2104 from the profile module 2102 to generate the contextual content 202. The profile module 2102, the current location module 2116, the additional location module 2118, the content discovery module 2124, the content generation module 2126, the comparison module 2136, the presentation module 2138, and the award module 2160 can be implemented as hardware accelerators (not shown) within the first control unit 2012, the second control unit 2034 of FIG. 20, or the third control unit 2052 of FIG. 20, or can be implemented in as hardware accelerators (not shown) in the first device 102, the second device 106, or the third device 108 outside of the first control unit 2012, the second control unit 2034, or the third control unit 2052.

Referring now to FIG. 22, therein is shown a flow chart of a method 2200 of operation of the content delivery system 100 of FIG. 1 in a further embodiment of the present invention. The method 2200 includes: determining a profile in a block 2202; calculating a current location associated with the profile in a block 2204; and generating a contextual content based on the profile and within a geofence of the current location for displaying on the device, the geofence is for connecting a device to another device in a block 2206.

Thus, it has been discovered that the content delivery system of an embodiment of the present invention furnishes important and heretofore unknown and unavailable solutions, capabilities, and functional aspects for a content delivery system with content sharing mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the an embodiment of present invention is that it valuably supports and services the historical trend of reducing costs, simplifying systems, and increasing performance. These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A content delivery system comprising:
a profile module configured to determine a profile;
a current location module, coupled to the profile module, configured to calculate a current location associated with the profile; and
a content generation module, coupled to the additional location module, configured to generate a contextual content based on the profile and within a geofence of the current location for displaying on the device, the geofence is for connecting a device to another device.

2. The system as claimed in claim 1 wherein the content generation module is configured to generate the contextual content based on a social graph.

3. The system as claimed in claim 1 further comprising a presentation module, coupled to the content generation module, configured to generate a shadow content based on the contextual content, the shadow content remains at a venue location.

4. The system as claimed in claim 1 wherein the content generation module is configured to generate the contextual content based on a recommendation reputation.

5. The system as claimed in claim 1 further comprising an award module, coupled to the content generation module, configured to determine an award point based on a promotional level for recommending the contextual content.

6. The system as claimed in claim 1 further comprising a presentation module, coupled to the content generation module, configured to present the contextual content based on a presentation rule.

7. The system as claimed in claim 1 wherein the content generation module is configured to generate the contextual content based on a content interest and a social graph.

8. The system as claimed in claim 1 wherein the presentation module is configured to generate a shadow content based on the contextual content, the shadow content remains at a venue location for a specific duration.

9. The system as claimed in claim 1 wherein the content generation module is configured to generate the contextual content based on a recommendation reputation and a content quality.

10. The system as claimed in claim 1 further comprising an award module, coupled to the content generation module, configured to determine an award point based on a promotional level, the award point is for recommending the contextual content and the contextual content has been viewed.

11. A method of operation of a content delivery system comprising:
determining a profile with a control unit;
calculating a current location associated with the profile; and
generating a contextual content based on the profile and within a geofence of the current location for displaying on the device, the geofence is for connecting a device to another device.

12. The method as claimed in claim 11 wherein generating the contextual content includes generating the contextual content based on a social graph.

13. The method as claimed in claim 11 further comprising generating a shadow content based on the contextual content, the shadow content remains at a venue location.

14. The method as claimed in claim 11 wherein generating the contextual content includes generating the contextual content based on a recommendation reputation.

15. The method as claimed in claim 11 further comprising determining an award point based on a promotional level for recommending the contextual content.

16. The method as claimed in claim 11 further comprising presenting the contextual content based on a presentation rule.

17. The method as claimed in claim 11 wherein generating the contextual content includes generating the contextual content based on a content interest and a social graph.

18. The method as claimed in claim 11 further comprising generating a shadow content based on the contextual content, the shadow content remains at a venue location for a specific duration.

19. The method as claimed in claim 11 wherein generating the contextual content includes generating the contextual content based on a recommendation reputation and a content quality.

20. The method as claimed in claim 11 further comprising determining an award point based on a promotional level, the award point is for recommending the contextual content and the contextual content has been viewed.
